(19) United States
(12) Patent Application Publication
(10) Pub. No.: US 2004/0066302 A1
(43) Pub. Date: Apr. 8, 2004

(54) Interactive motion sensitive sensor

(76) Inventors: Raymond J. Menard, Hastings, MN (US); McNeil Bryan, Amery, WI (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/601,330

(22) Filed: Jun. 20, 2003

Related U.S. Application Data
(63) Continuation of application No. 10/290,097, filed on Nov. 7, 2002.
Application No. 10/290,097 is a continuation of application No. 10/112,066, filed on Mar. 28, 2002, now abandoned.
(60) Provisional application No. 60/279,520, filed on Mar. 28, 2001.

(51) Int. Cl. G08B 21/00

(52) U.S. Cl. 340/669

(57) ABSTRACT

Portable accelerometer coupled to a processor and wireless transceiver providing remote monitoring of sensed acceleration. A BLUETOOTH®-compatible transceiver allows bi-directional communication including transmission of operating parameters and programming as well arm and cancel commands. Networked communications allows remote monitoring and integration with public safety answering point (PSAP). Signal processing at the portable device discerns includes comparison of sensed acceleration with stored profile.

### RELATED APPLICATIONS

This application is a continuation of U.S. patent application Ser. No. 10/290,097, filed on Nov. 7, 2002, which is a continuation of U.S. patent application Ser. No. 10/112,066, filed on Mar. 28, 2002, now abandoned, which claims the benefit under 35 U.S.C. 119(e) of U.S. Provisional Application No. 60/279,520 (entitled INTERACTIVE MOTION SENSITIVE SENSOR, and filed on Mar. 28, 2001), the specifications of which are incorporated herein by reference.

This application is related to U.S. Pat. No. 6,356,192, issued Mar. 12, 2002, entitled BI-DIRECTIONAL WIRELESS DETECTION SYSTEM, filed on Aug. 27, 1999, application Ser. No. 09/384,165, the specification of which is herein incorporated by reference.

This application is related to U.S. patent application Ser. No. 09/956,474 (entitled BI-DIRECTIONAL WIRELESS DETECTION SYSTEM, and filed on Sep. 19, 2001), the specification of which is herein incorporated by reference application Ser. No. 09/956,474 is a continuation of application Ser. No. 09/384,165.

### TECHNICAL FIELD

This document relates generally to security or monitoring systems, devices and methods and particularly, but not by way of limitation, to an accelerometer based wireless sensor.

### BACKGROUND

In the building or premises security industry, particularly the residential sector, it is customary to protect doors and windows with magnetic switches and one or more interior areas with motion detectors which detect the movement of a person within a predetermined area. In practice, it is often not practical, or affordable, to monitor all door and window openings. Thus the premises may remain vulnerable to intrusion or theft.

Security systems typically include commercially provided remote monitoring services. For those systems not commercially monitored, a high intensity audible alarm signal is sounded when an intrusion or breach is detected. Bystanders, and others, upon hearing the alarm signal are increasingly unlikely to place a telephone call to an emergency service to report the alarm condition. Instead, however, the sounding alarm is often construed as a nuisance and thus, ignored.

Traditional security systems are often professionally installed, and thus, are unsuited for portable applications. The costs associated with traditional security systems, including acquisition, installation, and monitoring charges, has led to low consumer acceptance rates.

Therefore, there is a need for an improved security system that provides low cost protection without the above enumerated disadvantages of traditional installations.

### SUMMARY

The present subject matter is directed to apparatuses, systems and methods for a wireless motion sensitive alarm device adapted for portable use. In one embodiment, a battery operated device wirelessly transmits a signal to a remote transceiver in response to a detected motion, movement, vibration or displacement. The system may include both a local transmitter and a local receiver. The device includes a processor coupled to an accelerometer and is adapted to transmit a wireless signal. In one embodiment, an alarm signal is transmitted until an acknowledgment signal is received. The acknowledgment signal may be transmitted by a remote transmitter. In one embodiment, the device communicates using BLUETOOTH™. BLUETOOTH™ refers to a spread spectrum, frequency hopping, transmission protocol operating at a frequency of approximately 2.45 GHz.

In one embodiment, the device includes a wireless transceiver compatible with a cellular telephone communication protocol, pager communication protocol or other long range wireless communication protocol. One embodiment of the device includes both a long range communication transceiver and a short range communication transceiver.

In one embodiment, the device includes a hanging loop, mounting surface, clip, clamp, or other structure to facilitate affixation to an item or surface to be monitored. Inertial forces acting on the device, when the device is moved or disturbed, trigger transmission of the alarm signal. When suspended from a door knob, or otherwise affixed to a premises or object, the present subject matter can be adapted to function as a security system.

Other aspects of the invention will be apparent on reading the following detailed description of the invention and viewing the drawings that form a part thereof.

### BRIEF DESCRIPTION OF THE DRAWINGS

In the drawings, like numerals describe substantially similar components throughout the several views. Like numerals having different letter suffixes represent different instances of substantially similar components.

FIG. 1 illustrates a block diagram of one embodiment of the present subject matter.

FIG. 2 illustrates a schematic of an accelerometer in accordance with one embodiment of the present subject matter.

FIG. 3A illustrates a schematic of an accelerometer in accordance with one embodiment of the present subject matter.

FIG. 3B illustrates a schematic of a mercury-based accelerometer in accordance with one embodiment of the present subject matter.

FIG. 4 illustrates a schematic of a processing section according to one embodiment of the present subject matter.

FIGS. 5A, 5B and 5C illustrate block diagrams of different communication sections according to embodiments of the present subject matter.

FIG. 6 illustrates a perspective view of one embodiment of the present subject matter adapted for installation by hanging.

FIG. 7 illustrates a flow chart in accordance with a method of using the present subject matter.

FIG. 8A illustrates a schematic for communicating using the present subject matter.

FIG. 8B illustrates a schematic for communicating using the present subject matter.

FIG. 9 is a block diagram of an example embodiment of a system according to the present subject matter.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

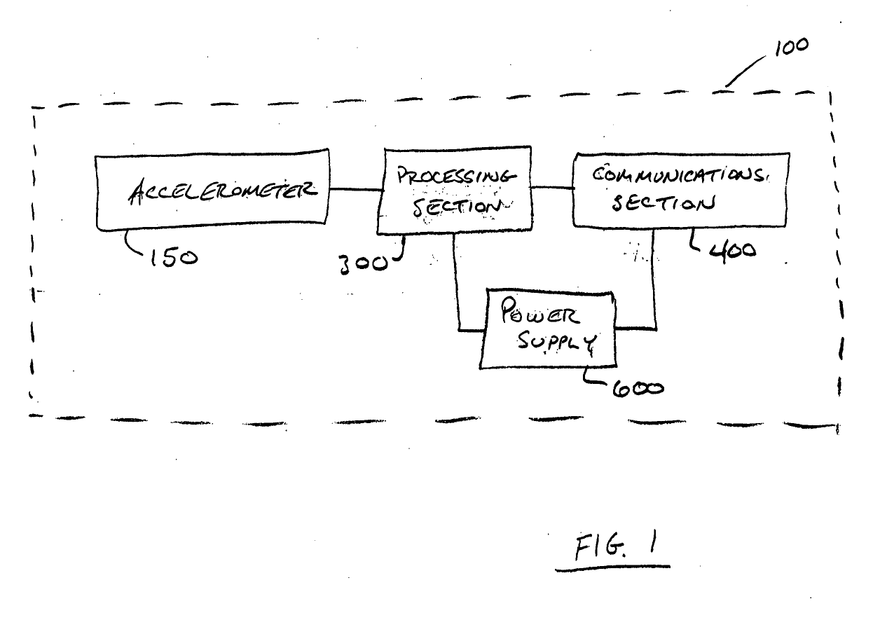

By way of overview, and with reference to FIG. 1, device 100 includes accelerometer 150, processing section 300 and communication section 400. Accelerometer 150 provides an electrical output signal based on a sensed physical acceleration. Processing section 300 receives the electrical signal, performs signal processing and generates a status signal. The status signal is received by communication section 400 and wirelessly communicated to a remote device or other communication network. In one embodiment, communication section 400 receives a wireless signal and provides data, coding, or instructions to processing section 300. Received wireless signals may be used to configure the operation of accelerometer 150, processing section 300 or communication section 400.

Device 100 is adapted for rigid or non-rigid affixation to an object to be protected or monitored. When the monitored object is disturbed or undergoes an acceleration, then a signal based on the acceleration is transmitted to a remote location.

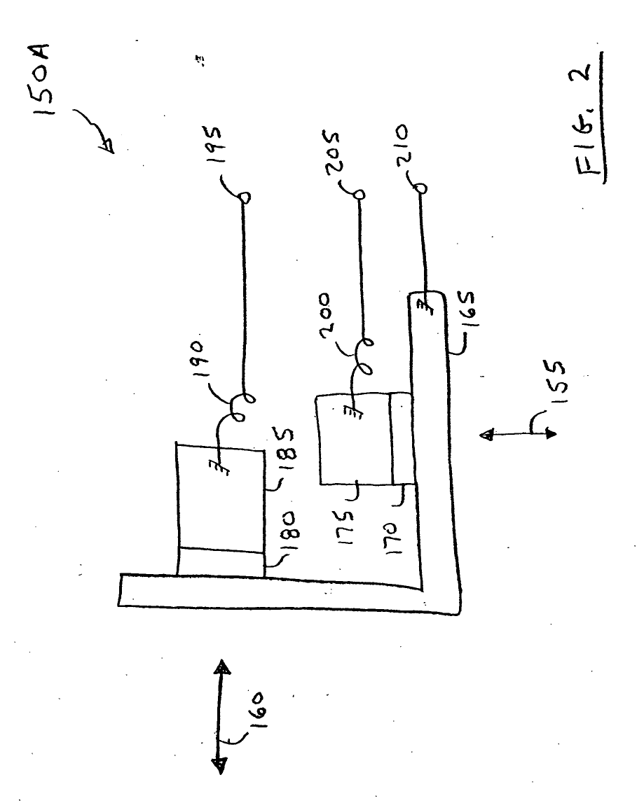

FIG. 2 illustrates a view of accelerometer 150A in accordance with the present system. In one embodiment, accelerometer 150 provides an electrical signal based on a sensed physical vibration, shock or inertial forces. The figure provides an example of accelerometer 150A having two axis of sensitivity, denoted herein by arrows 155 and 160. Arrows 155 and 160 are substantially orthogonal, however, other alignment is also contemplated. Motion, vibration or acceleration along axis 155 is sensed by accelerometer 150A and an electrical output signal is produced at terminals 205 and 210. Mass 175 is coupled to piezoelectric element 170 which, in turn, is coupled to electrically conductive structure 165. Structure 165 and terminal 210 are at equipotential. Motion, vibration or acceleration along axis 160 is sensed by accelerometer 150A and an electrical output signal is produced at terminals 195 and 210. Mass 185 is coupled to piezoelectric element 180 which, in turn, is coupled to electrically conductive structure 165. Terminals 195 and 205 are coupled to conductive mass 185 and conductive mass 175, respectively. Accelerometer 150A of FIG. 2 includes two detection elements and is sensitive to motion, vibration or acceleration along two axis, however, accelerometers having more than two elements or sensitive to more than two axis are also contemplated. For example, a three element accelerometer may be provided for detecting accelerations along an orthogonal coordinate system denoted as x, y and z. In addition, an accelerometer having a single element may detect accelerations along more than one axis. Multiple accelerometers may be configured to provide additional sensitivity or redundancy to accelerations along a particular axis or plane of motion. Piezoelectric elements 170 and 180 produce an analog electrical signal based on a pressure exerted on the elements.

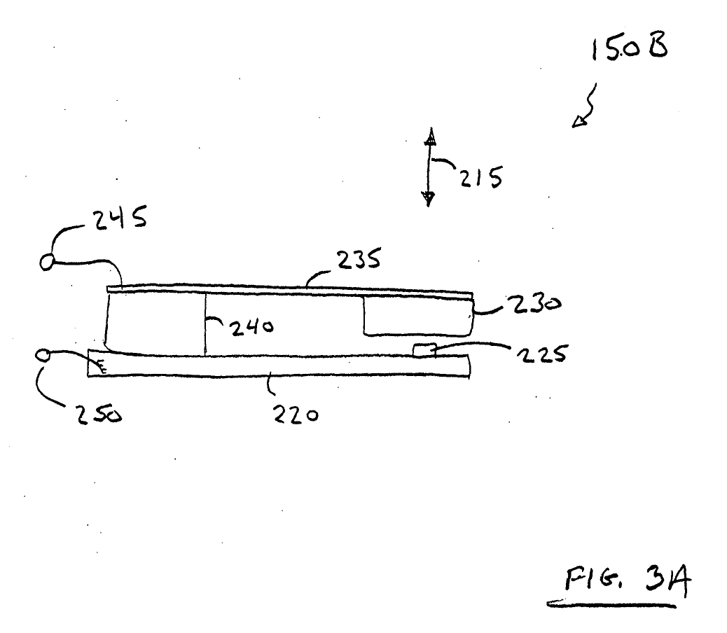

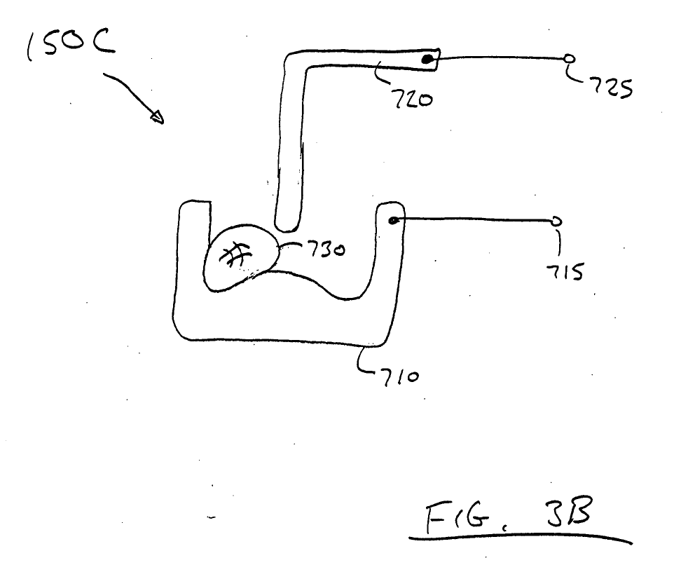

FIG. 3A illustrates accelerometer 150B in accordance with one embodiment of the present subject matter. In the figure, output terminals 245 and 250 are coupled to electrically conductive beam 235 and electrically conductive base 220, respectively. Beam 235 is separated from base 220 by beam support 240 and is weighted by mass 230. Base 220 carries electrical contact 225. Deflection of beam 235 under the forces of acceleration along the axis denoted by arrow 215 causes contact 225 to close an electrical circuit with mass 230. Accelerometer 150B illustrates a normally open sensor and produces a binary signal corresponding to open or closed. A normally closed sensor is also contemplated.

Other accelerometers are also contemplated, including but not limited to, for example those employing a micro-mechanical or nanofabricated structure, a mercury switch, a cantilevered beam, a flexible beam, a resistive element or a weighted switch. The output electrical signal from the accelerometer may be based on a variable resistance, capacitance or other measurable parameter or based on a binary signal. In one embodiment, the electrical output signal is a digital signal or an analog signal. In one embodiment, the present subject matter includes an accelerometer having a single pole, single throw (SPST) mercury switch element. The switch is in one electrical state when the switch is at rest and in the other electrical state when a disturbance, vibration or motion occurs.

In one embodiment, movement of the sensor causes a ball to make or break contact with an array of electrodes. The sensor may be sensitive to motion, or vibration, in a particular direction or plane. For example, one sensor may have maximum sensitivity to horizontal motion and a second sensor may have maximum sensitivity to vertical motion. The sensors need not be of the same sensitivity and may respond differently based on a varying degree of motion or acceleration. In one embodiment, the sensor outputs are characterized by a chopped make or break signal corresponding to the mechanical resonance of the ball or other structure.

FIG. 3B illustrates accelerometer 150C according to one embodiment of the present subject matter. In the figure, vessel 710 is fabricated of electrically conductive material and includes electrical terminal 715. Vessel 710 has a raised center at the bottom of the interior portion. Electrically conductive electrode 720 is positioned above vessel 710. Mercury ball 730 is at rest inside vessel 710. When accelerometer 150C is accelerated in a particular direction, mercury ball 730 is displaced and closes an electrical circuit between electrode 720 and vessel 710. The electrical output of accelerometer 150C is provided at 725 and 715. A housing (not shown) encapsulating vessel 710 and electrode 720 prevents mercury ball 730 from spilling.

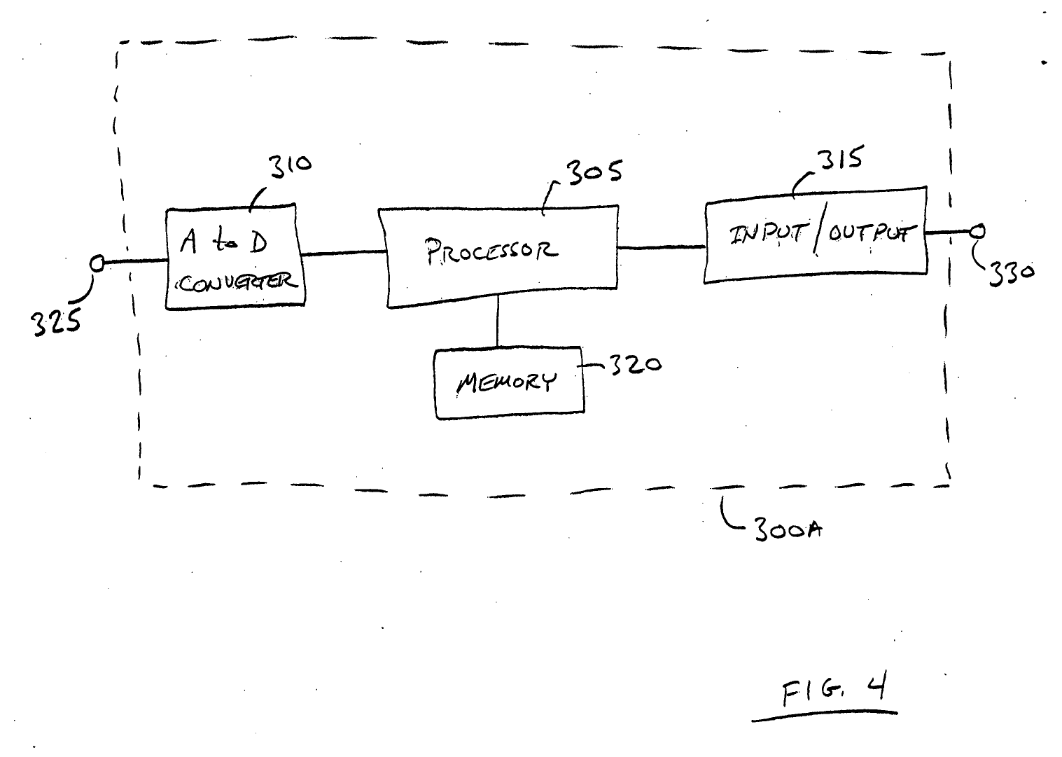

FIG. 4 illustrates processing section 300A including processor 305. In the figure, processor 305 is coupled to analog-to-digital converter 310 which, in turn, is coupled to input 325. In one embodiment, input 325 is coupled to the output of accelerometer 150. Processor 305 is coupled to memory 320 and input/output 315 having bus or terminal 330. Processor 305 may include a microprocessor adapted to execute programming (software or firmware) stored in memory 320. Processor 305 may include an analog or digital processor. Memory 320 also provides data storage for use by the processor. Memory 320 may include random access memory (RAM), read only memory (ROM), both, or other type of memory.

Processing section 300A, in one embodiment, performs signal processing based on data or a signal received from accelerometer 150. In one embodiment, analog-to-digital converter is included in accelerometer 150. In one embodiment, the processor receives a binary, digital or analog signal from accelerometer 150 without need for an analog-to-digital converter.

In one embodiment, signal processing performed by processing section 300 includes analysis of a frequency response received from accelerometer 150. Frequency response analysis may include comparing a received response profile with those stored in memory 320. For example, stored responses may represent accelerometer outputs when accelerated by the sound of a slamming door or breaking glass. Profiles of other sounds, motions or vibrations may also be stored and compared with inputs received from accelerometer 150. In one embodiment, the profiles are user programmable.

The present subject matter includes programming to identify selected acceleration events and trigger an alarm accordingly. Thus, in one embodiment, programming executing at device 100 is adapted to filter the spectrum content and attenuate, or remove, certain content not normally associated with a security threat. For example, in one embodiment, slight tremors of the earth, arising from geographical phenomena or nearby heavy roadway traffic, is filtered out and ignored for purposes of generating an alarm. Filtering may entail using a high frequency bandpass filter.

In one embodiment, a quiescent signal is used for a baseline and departures from the quiescent signal exceeding a particular threshold are deemed to represent an alarm condition or signal. Processing section 300 provides an output at terminal 330 indicating an alarm condition has been sensed.

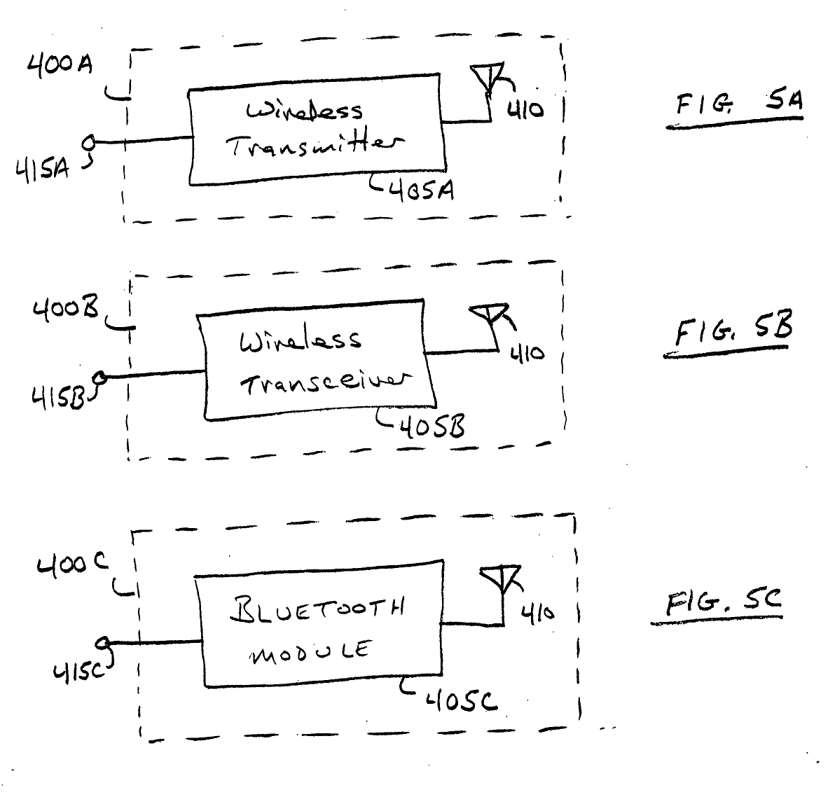

FIGS. 5A, 5B and 5C illustrate embodiments of communications section 400. In FIG. 5A, communications section 400A includes wireless transmitter 405A coupled to antenna 410. Transmitter 405A, in one embodiment includes a radio frequency (RF) transmitter adapted to broadcast an analog or digital signal. In one embodiment, input 415A includes a digital or analog signal input and receives a signal from the output of processing section 300. Input 415A may include a digital data bus.

In FIG. 5B, communications section 400B includes a wireless transceiver, having both a transmitter and a receiver, coupled to antenna 410. Terminal 415B, in one embodiment, includes a digital or analog signal input and receives a signal from the output of processing section 300. Terminal 415B may include a digital data bus. Terminal 415B, in one embodiment, includes a digital or analog signal output for communicating with processor section 300. The input or output signals may be communicated on a single conductor or on a multiconductor bus.

Communications section 400C, illustrated in FIG. 5C, includes BLUETOOTH® module 405C coupled to antenna 410. BLUETOOTH® is a trademark registered by Telefonaktiebolaget LM Ericsson of Stockholm, Sweden and refers to short range communication technology developed by an industry consortium known as the BLUETOOTH® Special Interest Group. BLUETOOTH® operates at a frequency of approximately 2.45 GHz, utilizes a frequency hopping (on a plurality of frequencies) spread spectrum scheme, and provides a digital data transfer rate of approximately 1 Mb/second. BLUETOOTH® transceivers have a range of approximately 10 to 100 meters (and sometimes more) and by combining several BLUETOOTH® transceivers in an ad hoc network, the communication range can be extended indefinitely. Ad hoc networking refers to the ability of one transceiver to automatically detect and establish a digital communication link with another transceiver. The resulting network, known as a piconet, enables each transceiver to exchange digital data with the other transceiver. According to one embodiment, BLUETOOTH® involves a wireless transceiver transmitting a digital signal and periodically monitoring a radio frequency for an incoming digital message encoded in a network protocol. The transceiver communicates digital data in the network protocol upon receiving an incoming digital message.

The communication range can also be extended by coupling a BLUETOOTH® transceiver with a second transceiver coupled to a long range network, such as a cellular telephone network or pager network. BLUETOOTH®compatible devices are generally self-aware in that each device executes an automatic routine to identify other nearby compatible devices.

In one embodiment, communications section 400C includes a BLUETOOTH® transceiver compatible with BLUETOOTH® technical specification 1.0.

In one embodiment, communications section 400 is compatible with HomeRF™, IEEE 802.11 or other wireless technology. IEEE is more formally known as the Institute of Electrical and Electronics Engineers, Inc. HomeRF™ describes a wireless communication protocol operating at 2.4 GHz frequency band and utilizes frequency-hopping spread spectrum RF technology. IEEE 802.11 describes a wireless local area network communication protocol.

In addition to BLUETOOTH®, HomeRF™ and IEEE 802.11, other wireless communication technology is also contemplated. For example, communication technology compatible with other standards within the IEEE 802® family of standards (such as IEEE 802.13 or 802.15) as well as infrared, ultrasonic, and optical based communication systems may also be used with the present subject matter. The IEEE 802.15 WPAN standard is anticipated to include the technology developed by the BLUETOOTH® Special Interest Group. WPAN refers to Wireless Personal Area Networks. The IEEE 802.15 WPAN standard is expected to define a standard for wireless communications within a personal operating space (POS) which encircles a person.

Communications section 400 is adapted to communicate an alarm signal. In one embodiment, communications section 400 is adapted to communicate programming, confirmation signals, transient signals or messages, or user selectable parameters. Other embodiments are also contemplated. For example, in one embodiment, communications section 400 transmits a signal after having been processed by processing section 300 or an unprocessed signal from accelerometer 150.

Communications section 400, in one embodiment, is adapted to receive a wireless confirming signal or acknowledgment from a remote transmitter. The remote transmitter may include a nearby transmitter compatible with communications section 400.

Device 100, shown in FIG. 1, includes power supply 600 coupled to processing section 300 and communications section 400. In one embodiment, power supply 600 is coupled to accelerometer 150. Power supply 600 provides a direct current energy supply and in various embodiments, includes, one or more batteries, solar panels or other current source.

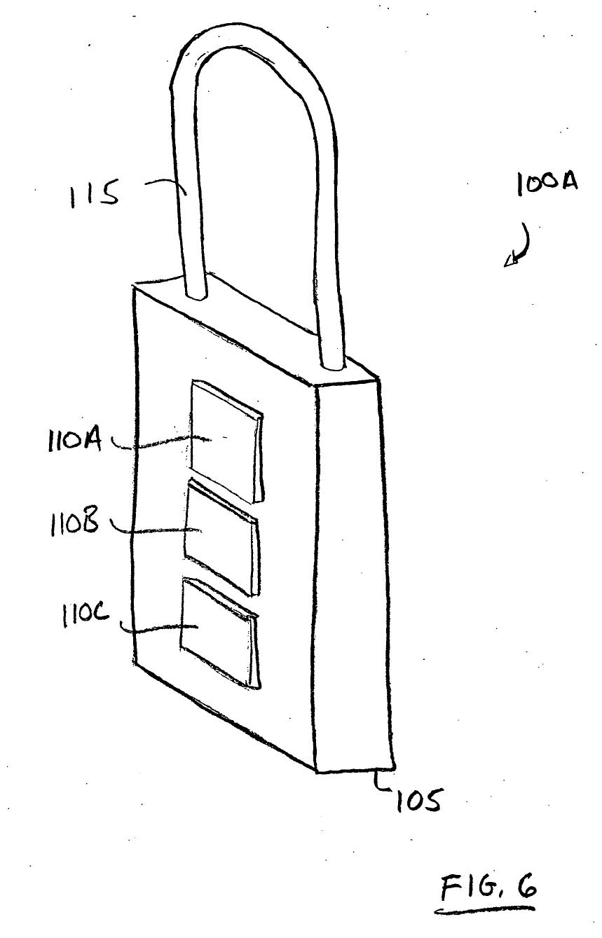

In one embodiment, device 100 is housed in a mechanical structure, such as, for example, but not by way of limitation, that illustrated in FIG. 6. In the figure, housing 105 provides mechanical protection for accelerometer 150, processing section 300, communications section 400 and power supply 600. Affixed to one end of housing 105 is hanger 115. Hanger 115 is adapted for looping over a door knob or other structure to be monitored for acceleration. A mechanical release assembly, not shown in the figure, and located, for example but not by way of limitation, at the bottom of housing 105, disengages a portion of hanger 115 to allow device 100A to be suspended non-rigidly from the monitored structure. Device 100 may be affixed temporarily or permanently to the monitored structure.

A plurality of user operable buttons are disposed on a surface of housing 105. Buttons 110A, 110B and 110C, for example, but not by way of limitation, are adapted to control the operating mode of device 100A, power device 100A, and to manually cancel an alarm signal. In one embodiment, more or less buttons are included with each having a user operable function.

As illustrated in FIG. 6, device 100A is adapted for portable operation using a battery power supply. In other embodiments, device 100 is adapted for a dedicated installation for monitoring a particular structure. In such a case, device 100 includes tailored attachment hardware, including, but not limited to, a mechanical clamp, a clip, an adhesive mounting surface or other structure for rigidly, or semi-rigidly, affixing device 100 to the monitored structure. For example, a weak adhesive, hook and loop fasteners, double-back tape, screws, nylon tie-wraps, cord, a magnet or other mechanical attachment means may be used in various embodiments. In addition, for certain applications, device 100 may be placed at a position atop a structure to be monitored. In one embodiment, device 100 is adapted to be worn by a person or animal and in such cases, device 100 is suspended on a neck strap or strapped to a limb or trunk of a body.

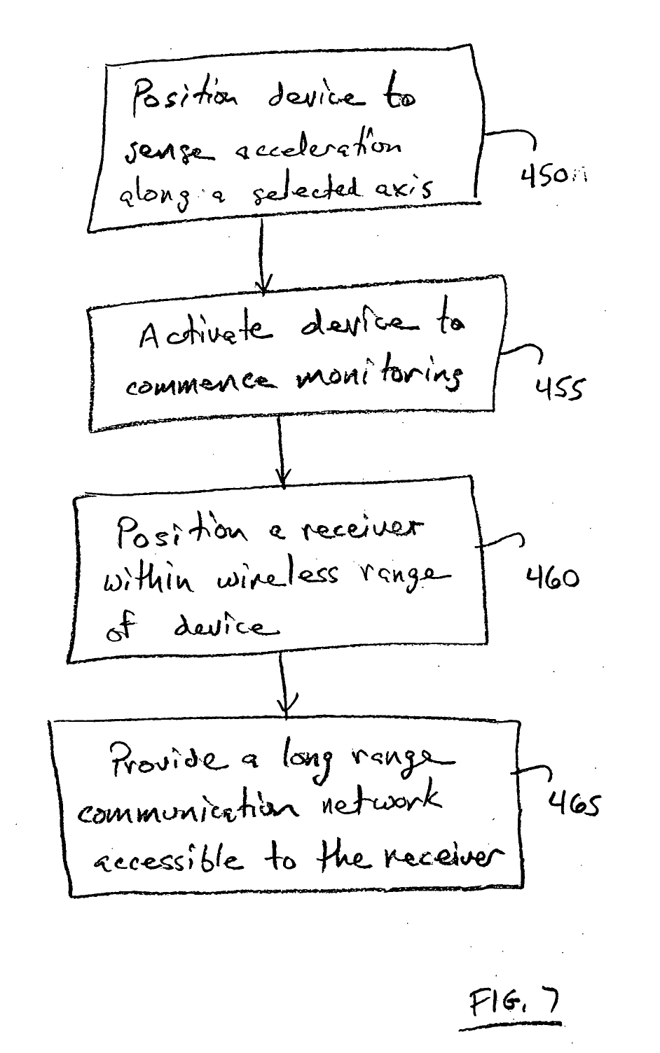

FIG. 7 illustrates a flow chart representing a method of using device 100. Starting at 450, device 100 is positioned in a manner to sense acceleration along a particular axis. For example, in one embodiment, the axis of sensitivity is aligned parallel to a direction of anticipated movement. At 450, device 100 is powered and activated to commence monitoring. In one embodiment, a visible light affixed to device 100 denotes that the device is powered and monitoring acceleration. At 460, a wireless receiver, compatible with communications section 400, is positioned within range of device 100. At 465, a long range communication network is provided which couples the wireless receiver to a remote monitoring service. The remote monitoring service may include a commercial monitoring service or a public safety answering point (PSAP) or other facility.

Other methods for using the present subject matter are also contemplated. For example, in one embodiment, an alarm signal is transmitted continuously, or periodically, until an acknowledgment signal or cancellation signal is received. In one embodiment, the acknowledgment signal or cancellation signal must be accompanied by a security code or password that authenticates the source of the signal. In one embodiment, the alarm signal is transmitted continuously, or periodically for a predetermined period of time.

A commercially provided monitoring service may be used with the present subject matter. In such an application, the monitoring service provider maintains a database of information concerning the user and particular device. When an alarm signal is received by the monitoring service, contact information and other date concerning the user and device are accessed. In one embodiment, the user information, and device information, is relayed, by the monitoring service, to an emergency service, such as a PSAP, medical emergency personnel or police personnel.

In one embodiment, device 100 includes a wireless transceiver adapted for relaying transient incoming signals in order to extend the range of communications. For example, in one embodiment, device 100 includes a BLUETOOTH® compatible transceiver and device 100 serves as an intermediary link to extend the communication range of particular communications not necessarily related to the accelerometer functions of the present subject matter.

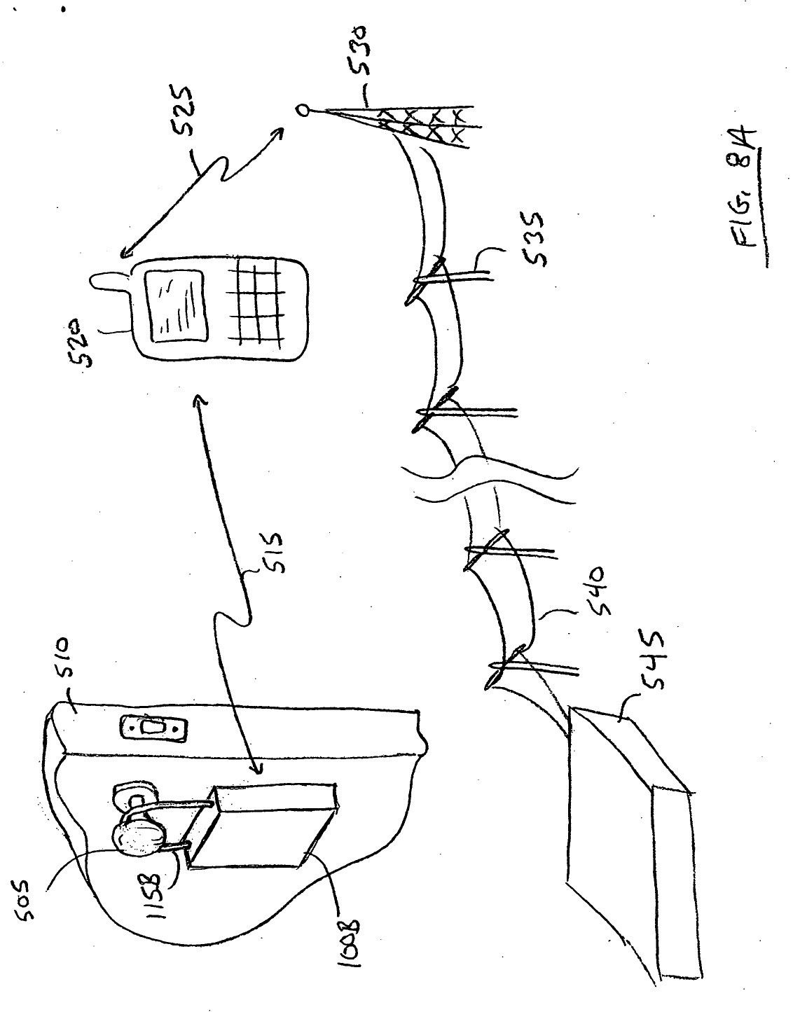

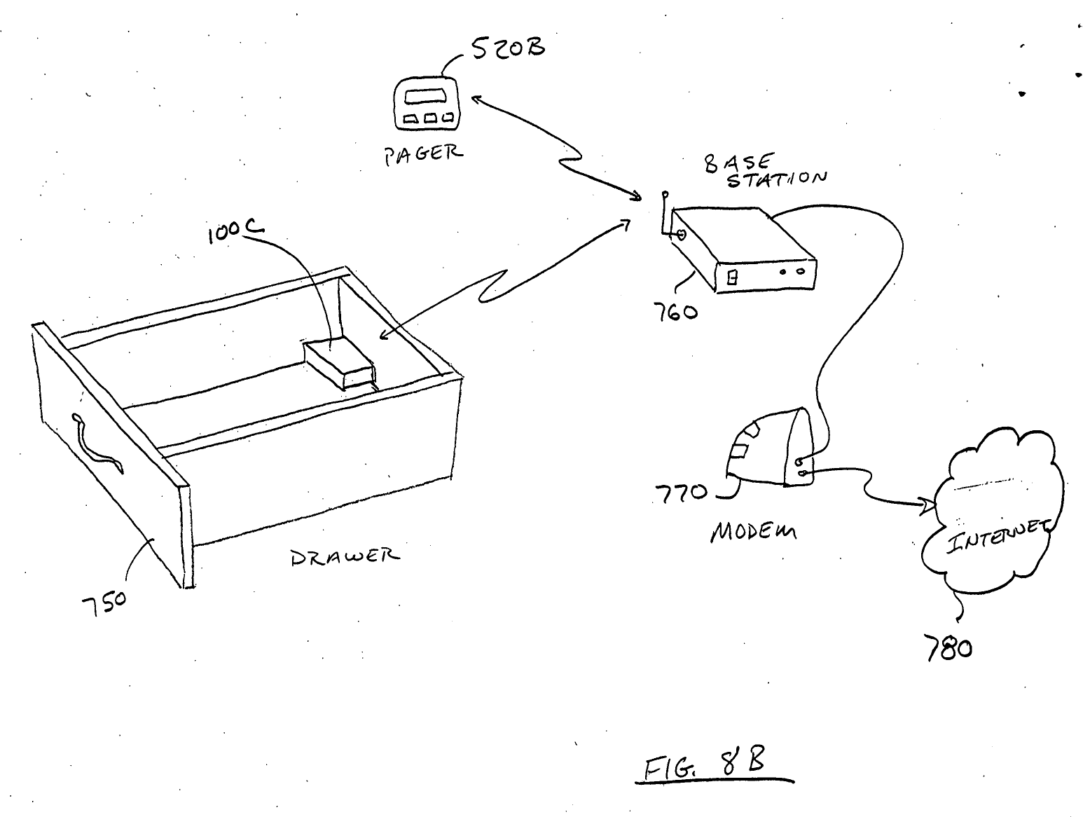

FIG. 8A illustrates device 100B affixed to interior doorknob 505 by hanger 115B. Door 510 is the monitored structure and here, for example but not by way of limitation, represents a door to a hotel room. In the figure, device 100B is in wireless communication with a compatible receiver of cellular telephone 5201A via link 515. The compatible receiver may be included in a one-way or two-way pager, a personal digital assistant (PDA), a personal communication system (PCS) device or other such portable or stationary device. In one embodiment, both cellular telephone 520A and device 100 include a BLUETOOTH® compatible transceiver. In one embodiment, device 100 includes a short range communication section and a long range communication section.

Link 525 of the figure represents cellular telephone communications between cellular telephone 520A and a cellular telephone communication network, herein represented by a cellular telephone tower 530. The cellular telephone communication network is coupled to a public switched telephone network, here denoted by telephone lines 535 and 540. Telephone lines 540 are coupled to monitoring service 545. Monitoring service 545 is further coupled, by telephone lines, e-mail, cellular telephone network, radio, or other communication means to a PSAP or other emergency response service.

In operation, when device 100B senses an acceleration exceeding a predetermined magnitude or meeting, or not meeting, a particular stored profile, then a wireless signal is communicated to cellular telephone 520A. Cellular telephone 520A notifies a user either by vibration, audible tone, or visible light signal. If the user does not respond within a predetermined time, then cellular telephone 520A further propagates the signal by relaying the alarm signal to the monitoring service via the cellular telephone network and the PSTN. Other means of propagating the signal are also available, including e-mail communication, radio communication, pager communication, cellular communication or other long range or short range communication means.

A wireless signal propagated from device 100 may include a signal compatible with a cellular telephone transceiver, a pager transceiver, a radio or other long or short range communication devices.

The above example illustrates a method, pursuant to the present subject matter, utilizing cellular telephone 520A. Other communication devices are also contemplated. For example, but not by way of limitation, the wireless alarm signal may be transmitted using a stationary host device adapted for wireless communications and coupled to a long range communication network. In addition, other devices are contemplated for communicating the alarm signal using a series of short range communications. For example, a building management or security system having elements equipped with compatible transceivers may also be used to receive and propagate wireless signals from the present subject matter.

In one embodiment, a single monitoring device is adapted to receive signals from a plurality of individual accelerometer devices 100. For example in a shipping context, a number of packages, each having a device 100, are monitored using a single receiver. Excessive disturbances, acceleration or vibration of any package is then communicated automatically to the monitoring receiver.

In one embodiment, device 100 includes a signaling means to indicate that the accelerometer has sensed an excursion from normal or expected values. For example, in one embodiment, processing section 150 is coupled to an audible sound generator or a visual indicator. A sound generator may include a speaker, a piezoelectric sounding device or other audio transducer. A visual indicator may include a light emitting diode (LED), a liquid crystal display (LCD), indicator lamp or other display device. In one embodiment, the receiver associated with the present subject matter includes an audible sound generator or visual indicator.

In one embodiment, the receiving monitor may be coupled to a communication network by a wireless or wired connection. For example, a BLUETOOTH®-equipped computer may be coupled to a local area network (LAN) by a wired connection or coupled to the Internet, or other wide area network (WAN) using a wireless connection.

The present subject matter may be manufactured by coupling an accelerometer with a processor. In one embodiment, the accelerometer output includes an analog signal and the processor is interfaced using an analog-to-digital converter. The processor is coupled to a wireless transmitter or transceiver. The accelerometer, processor and transceiver (or transmitter) is coupled to a portable power supply. A memory accessible to the processor provides storage for an executable program for controlling the operation of the device.

FIG. 8B illustrates device 100C placed inside of drawer 750. Device 100C may be mechanically attached or unattached to drawer 750. Mechanical attachment may include an adhesive bond, tape, a wood screw or a threaded fastener. Drawer 750 may represent a kitchen drawer or file drawer, the contents of which are to be monitored. Device 100C is in wireless communication with base station 760. In one embodiment, base station 760 is located at the premises. In one embodiment, the wireless communication link between device 100C and base station 760 conforms to BLUETOOTH® standards. In the figure, base station 760 is further coupled to modem 770 which is coupled to network 780. In one embodiment, modem 770 includes a cable modem coupled to the Internet. A remote browser can be used to access base station 760 via modem 770 and thus, transmit and receive data with device 100C. In the figure, base station 760 is in wireless communication with pager 520B. Pager 520B, in one embodiment, includes a two-way pager and is adapted to communicate with device 100C via base station 760. In one embodiment, base station 760 is adapted to communicate with other wireless devices using a radio frequency communication channel.

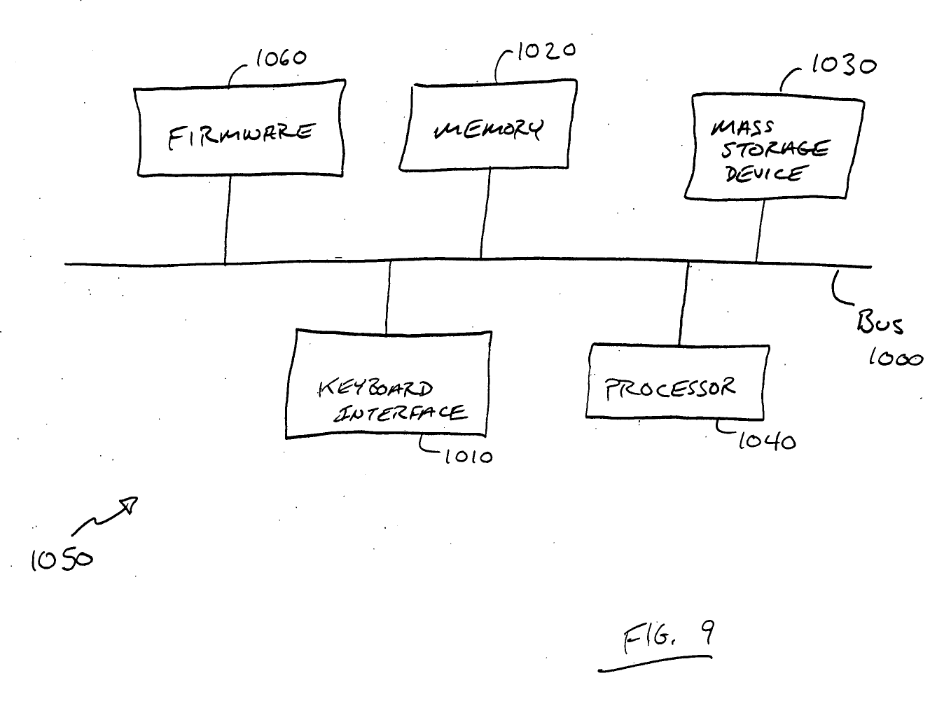

FIG. 9 includes a block diagram of a system, such as a computer system 1050, in accordance with one embodiment of the present subject matter. Computer system 1050 includes bus 1000, keyboard interface 1010, external memory 1020, mass storage device 1030, processor 1040 and firmware 1060. Bus 1000 may be a single bus or a combination of multiple buses. Bus 1000 provides communication links between components in the system. Keyboard interface 1010 may be a dedicated device or may reside in another device such as a bus controller or other controller. Keyboard interface 1010 allows coupling of a keyboard to the system and transmits signals from a keyboard to the system. External memory 1020 may comprise a dynamic random access memory (DRAM) device, a static random access memory (SRAM) device, or other memory devices. External memory 1020 stores information from mass storage device 1030 and processor 1040 for use by processor 1040. Mass storage device 1030 may be a hard disk drive, a floppy disk drive, a CD-ROM device, or a flash memory device or the like. Mass storage device 1030 provides information to external memory 1020. Firmware 1060 is nonvolatile memory programmed with data or instructions. Examples of firmware 1060 include, but are not limited to, read-only memory (ROM), programmable read-only memory (PROM), and electrically erasable programmable read-only memory (EEPROM), and flash memory.

Alternative Embodiments

The foregoing description relates to a set of particular embodiments. Alternatives are also contemplated, as described in the following section.

In one embodiment, the device 100 is positioned to detect an acceleration. This may include mechanically attaching device 100 to an object. In one embodiment, the object is a household item, such as a kitchen drawer, a gun safe, a liquor cabinet, a television set or other hazardous or high value item. In one embodiment, the user next establishes a relationship between device 100 and a wireless receiver device. For example, using a cellular telephone, the present system allows a user to open a communication channel to device 100 and establish programming that causes device 100 to report detected events to the cellular telephone or other user specified device. When so configured, device 100 is precluded from corresponding with non-authorized devices. As such, a detected event is reported from device 100 to the authorized devices as specified by the user. Thereafter, the user may again use the cellular telephone, or other associated, compatible communication transceiver, to set device 100 into an armed mode, or cancel an alarm, or disarm device 100, or otherwise change the operating mode of device 100. In one embodiment, device 100 exchanges security keys with a compatible transceiver to establish an authorized association. The security keys may include public key infrastructure (PKI) keys.

In one embodiment, device 100 is configured by a user at the time of installation at a premises. In one embodiment, multiple instances of device 100 may be programmed in a batch mode such that each device 100 reports to a selected transceiver in a predetermined manner. In one embodiment, device 100 reports detected events to a plurality of transceivers as specified by the user.

In one embodiment including a BLUETOOTH®-compatible transceiver, device 100 remains active when detected events exceed a particular threshold and reverts to a “sleep” mode for periods of time when no activity is detected. In one embodiment, device 100 includes a signal processor or other processor to analyze the detected events. In one embodiment, detected events are analyzed by device 100 and if so configured, an alarm signal is transmitted to a receiver for those detected events meeting predetermined parameters.

In one embodiment, device 100 is adapted for responding to voice commands. In this embodiment, a processor of the present subject matter decodes received spoken words or instructions and adapts the operation of device 100 accordingly. A processor of the present subject matter is adapted to authenticate the source of the spoken instruction or command to prevent unauthorized disablement or tampering by non-authorized persons.

In one embodiment, one or more user operable controls are accessible from the exterior of the present subject matter. For example, a control may be tailored to allow a user to set a quiescent level of ambient vibration level or noise using a particular button. As another example, a control may allow the user to set a sensitivity level for sensed accelerations. The sensitivity level may relate to the duration of a particular acceleration.

In one embodiment, visible or audible output signals from device 100 may provide confirmation of the operational mode or settings of device 100.

In one embodiment, a plurality of stored patterns correspond to alarm conditions or non-alarm conditions. The received signals from the accelerometer are compared with the stored patterns and, if appropriate, an alarm signal is generated. The stored patterns may differ according to amplitude, direction of acceleration, duration, phase of acceleration or other measurable parameters.

In one embodiment, the executable programming for the processing section 150 is upgradable by remote access. For example, programming may be downloaded to device 100 by communicating using communications section 400. In addition, operating parameters or stored patterns of acceleration may also be upgraded remotely.

In one embodiment, the present subject matter is adapted to monitor a mobile patient. For example, the present subject matter may be coupled to a limb or trunk of a body and allow remote monitoring of acceleration levels.

In one embodiment, the present subject matter provides a continuous data stream to a receiver or monitor corresponding to sensed accelerations. In such a device, the processing section is adapted for smoothing or other signal processing of the data prior to transmission using the communications section.

In one embodiment, device 100 executes a self-test to verify operability of selected functions of the present subject matter. For example, the self-test mode may be executed on a periodic schedule, on a remote user selected schedule or randomly. The self-test may be adapted to verify the communication link, verify operation of the accelerometer functionality or verify programming modes.

In one embodiment, the alarm or data signal includes location information for device 100. Location information may be generated using a integrated global positioning system (GPS) receiver or other technology. In one embodiment, alarm signal forwarded to the remote monitoring facility includes an approximate location based on information derived from a receiver nearby the location of device 100. In one embodiment, the alarm signal or data includes source identifier information for the particular device 100.

In one embodiment, the accelerometer includes one or more switches and the processing section monitors the output of the one or more switches. If the switches have been at rest for a period, the processing section assumes that subsequent activity may be a motion alarm. When motion is detected, and before sending an alarm signal, the processing section analyzes the signature of the chopped switch output to filter false alarm signals caused, for example, by the slamming of a nearby door. In one embodiment, the processing section performs signal analysis or filtration before transmitting an alarm signal.

In one embodiment, the device is adapted for wirelessly communicating with a remote monitoring facility or central station. The central station may provide commercial monitoring services for the present subject matter and detected events are communicated to the service. The central station is adapted to dispatch emergency service personnel under predetermined conditions. In one embodiment, the present subject matter includes an annunciator device. The annunciator device is in wireless communication with the accelerometer of the present subject matter. An alarm signal corresponding to a detected event is communicated to the annunciator device. The annunciator device includes an audible siren or other such audio transducer. In one embodiment, the annunciator includes a visible light adapted to signal a detected event.

The Network Module

The network module may be of several different designs. For example, in one embodiment it includes a response messaging capable two-way pager. This is service where a two-way pager receives a message and optional multiple-choice responses. The user can select the appropriate responses. Such a design may be adapted to provide basic control options related to the system.

In one embodiment, the network module includes a programmable two-way paging device such as the Motorola PageWriter™ 2000. This is a class of devices that acts as both a two-way pager and a handheld computer also known as a PDA (Personal Digital Assistant).

In one embodiment, the network module includes a cellular telephone. The cell phone may be analog or digital in any of the various technologies employed by the cell phone industry such as PCS, or CDMA, or TDMA, or others. The cell phone may have programmable capability such as is found in a Nokia™ 9000 series of devices.

In embodiments where the user employs standard or adapted paging or cell phones as their network module, security passwords may be entered by using numeric or other keys on a phone. In one embodiment, the security password may be entered by speaking words. In this embodiment, the system may use word recognition, voice recognition or a combination of these technologies. In the embodiment of a pager, a distinct order of pressing certain keys could provide the equivalent of a security code. For example, 3 short and 1 long on a certain key; or once on key ‘a’, once on key ‘b’, and once more on key ‘a’.

In one embodiment, the network module includes a handheld computer. Some PDAs offer programmable capability and connectivity to various types of long range wireless networks. An example of this type of device is the PalmPilot™ or Palm series of devices manufactured by 3-COM™. In these embodiments where a programmable network module is used, such as a PalmPilot, PageWriter or programmable cell phone, the programmable nature of the devices facilitates the implementation of industry-standard designs and allows for the development of a program written for the devices.

In one embodiment, a special manufactured device may be manufactured to serve the needs of the system user.

In one embodiment, the device is directly connected to a network module that is manufactured as an integrated unit.

Long Range Wireless Network

The network module incorporates a communications module to connect to a long range, bidirectional network. Such a system incorporates an existing wireless communications network, such as a cellular network, satellite network, paging network, narrowband PCS, narrowband trunk radio, or other wireless communication network. Combinations of such networks and other embodiments may be substituted without departing from the present system.

In one embodiment, the long range wireless network includes a cellular communications network. In one embodiment, the long range wireless network includes a paging network. In one embodiment the long range wireless network includes a satellite network. In one embodiment the long range wireless network includes a wideband or narrowband PCS network. In one embodiment the long range wireless network includes a wideband or narrowband trunk radio module. Other networks are possible without departing from the present system. In one embodiment, the network module supports multiple network systems, such as a cellular module and a two-way paging module, for example. In such embodiments, the system may prefer one form of network communications over another and may switch depending on a variety of factors such as available service, signal strength, or types of communications being supported. For example, the cellular network may be used as a default and the paging network may take over once cellular service is either weak or otherwise unavailable. Other combinations are possible without departing from the present system.

The long range wireless network may include any consumer or proprietary network designed to serve users in range of the detection system, including, but not limited to, a cellular network such as analog or digital cellular systems employing such protocols and designs as CDPD, CDMA, GSM, PDC, PHS, TDMA, FLEX™, ReFLEX™, iDEN™, TETRA™, DECT, DataTAC™, and Mobitex™, RAMNET™ or Ardis™ or other protocols such as trunk radio, Microburst™, Cellemetry™, satellite, or other analogue or digital wireless networks or the control channels or portions of various networks. The networks may be proprietary or public, special purpose or broadly capable. However, these are long range networks and the meaning imposed herein is not to describe a premises or facility based type of wireless network.

The long range wireless network may employ various messaging protocols. In one embodiment Wireless Application Protocol (WAP) is employed as a messaging protocol over the network. WAP is a protocol created by an international body representing numerous wireless and computing industry companies. WAP is designed to work with most wireless networks such as CDPD, CDMA, GSM, PDC, PHS, TDMA, FLEX, ReFLEX, iDEN, TETRA, DECT, DataTAC, and Mobitex and also to work with some Internet protocols such as HTTP and IP. Other messaging protocols such as iMode™, WML, SMS and other conventional and unconventional protocols may be employed without departing from the design of the present embodiment.

As an example, these long range communication protocols described above may include, but are not limited to, cellular telephone protocols, one-way or two-way pager protocols, and PCS protocols. Typically, PCS systems operate in the 1900 MHZ frequency range. One example, known as Code-Division Multiple Access (CDMA, Qualcomm Inc., one variant is IS-95) uses spread spectrum techniques. CDMA uses the full available spectrum and individual messages are encoded with a pseudo-random digital sequence. Another example, Global Systems for Mobile communications (GSM), is one of the leading digital cellular systems and allows eight simultaneous calls on the same radio frequency. Another example, Time Division Multiple Access (TDMA, one variant known as IS-136) uses time-division multiplexing (TDM) in which a radio frequency is time divided and slots are allocated to multiple calls. TDMA is used by the GSM digital cellular system. Another example, 3G, promulgated by the ITU (International Telecommunication Union, Geneva, Switzerland) represents a third generation of mobile communications technology with analog and digital PCS representing first and second generations. 3G is operative over wireless air interfaces such as GSM, TDMA, and CDMA. The EDGE (Enhanced Data rates for Global Evolution) air interface has been developed to meet the bandwidth needs of 3G. Another example, Aloha, enables satellite and terrestrial radio transmissions. Another example, Short Message Service (SMS), allows communications of short messages with a cellular telephone, fax machine and an IP address. Messages typically have a length of 160 alpha-numeric characters. Another example, General Packet Radio Service (GPRS) is another standard used for wireless communications and operates at transmission speeds far greater than GSM. GPRS can be used for communicating either small bursts of data, such as e-mail and Web browsing, or large volumes of data.

In one embodiment, a long range communication protocol is based on one way or two way pager technology. Examples of one way pager protocols include Post Office Code Standardisation Advisory Group (POCSAG), Swedish Format (MBS), the Radio Data System (RDS, Swedish Telecommunications Administration) format and the European Radio Message System (ERMES, European Telecommunications Standards Institute) format, Golay Format (Motorola), NEC-D3 Format (NEC America), Mark IV/V/VI Formats (Multitone Electronics), Hexadecimal Sequential Code (HSC), FLEX™ (Motorola) format, Advanced Paging Operations Code (APOC, Philips Paging) and others. Examples of two way pager protocols include ReFLEX™ (Motorola) format, InFLEXion™ (Motorola) format, NexNet™ (Nexus Telecommunications Ltd. of Israel) format and others.

Other long range communication protocols are also contemplated and the foregoing examples are not to be construed as limitations but merely as examples.

The Short Range Wireless Network

In one embodiment, the short range wireless network utilizes a spread spectrum frequency hopping transceiver. This transceiver may communicate using a protocol compatible with BLUETOOTH®. BLUETOOTH® refers to a wireless, digital communication protocol using a low form factor transceiver that operates using spread spectrum frequency hopping at a frequency of around 2.45 GHz.

BLUETOOTH® is a trademark registered by Telefonaktiebolaget LM Ericsson of Stockholm, Sweden and refers to technology developed by an industry consortium known as the BLUETOOTH® Special Interest Group. BLUETOOTH® operates at a frequency of approximately 2.45 GHz, utilizes a frequency hopping (on a plurality of frequencies) spread spectrum scheme, and as implemented at present, provides a digital data transfer rate of approximately 1 Mb/second. Future implementations will include higher data transfer rates. In one embodiment, the present system includes a transceiver in compliance with BLUETOOTH® technical specification version 1.0, herein incorporated by reference. In one embodiment, the present system includes a transceiver in compliance with standards established, or anticipated to be established, by the Bluetooth Special Interest Group.

In one embodiment, the present system includes a transceiver in compliance with standards established, or anticipated to be established, by the Institute of Electrical and Electronics Engineers, Inc., (IEEE). The IEEE 802.15 WPAN standard is anticipated to include the technology developed by the BLUETOOTH® Special Interest Group. WPAN refers to Wireless Personal Area Networks. The IEEE 802.15 WPAN standard is expected to define a standard for wireless communications within a personal operating space (POS) which encircles a person.

In one embodiment, the transceiver includes a wireless, bidirectional, transceiver suitable for short-range, omni-directional communication that allows ad hoc networking of multiple transceivers for purposes of extending the effective range of communication. Ad hoc networking refers to the ability of one transceiver to automatically detect and establish a digital communication link with another transceiver. The resulting network, known as a piconet, enables each transceiver to exchange digital data with the other transceiver. According to one embodiment, BLUETOOTH® involves a wireless transceiver transmitting a digital signal and periodically monitoring a radio frequency for an incoming digital message encoded in a network protocol. The transceiver communicates digital data in the network protocol upon receiving an incoming digital message.

According to one definition, and subject to the vagaries of radio design and environmental factors, short range may refer to systems designed primarily for use in and around a premises and thus, the range generally is below a mile. Short range communications may also be construed as point-to-point communications, examples of which include those compatible with protocols such as BLUETOOTH®, HomeRF™, and the IEEE 802.11 WAN standard (described subsequently). Long-range, thus, may be construed as networked communications with a range in excess of short range communications. Examples of long range communication may include, Aeris MicroBurst cellular communication system, and various networked pager, cellular telephone or, in some cases, radio frequency communication systems.

In the event that the present subject matter includes a transceiver compatible with BLUETOOTH® protocol, for example, then the device may have sufficient range to conduct bidirectional communications over relatively short range distances, such as approximately 10 to 1,000 meters or more. In some applications, this distance allows communications throughout a premise.

The network module may include a separate, integrated or software based short range bidirectional wireless module. The short range network may be based upon HomeRF, 802.11, BLUETOOTH® or other conventional or unconventional protocols. However, these are short range networks and the meaning imposed herein is to include premises and facility based wireless networks and not to describe long range networks such as cellular telephone networks used to communicate over long distances. Such a system may include programmable or automatically selecting electronics to decide whether to conduct communications between the network module and an optional base station using the short range module or the network module. In one embodiment the system may employ different portions of the network to provide short range or long range network connections, depending on the distance between the devices and the base stations. In one such embodiment, the network automatically adjusts for different required transmission distances.

In one embodiment, the transceiver is compatible with both a long range communication protocol and a short range communication protocol. For example, a person located a long distance away, such as several miles, may communicate with the transceiver using a cellular telephone compatible with the long range protocol of transceiver.

Other short range communication protocols are also contemplated and the foregoing examples are not to be construed as limitations but merely as examples.

Networks Connected to the Premises Base Station

In one embodiment, the present system communicates with a device referred to herein as central communication base station. Central communication base station may include a first transceiver compatible with BLUETOOTH® or other short range wireless network as described herein. Base station may provide a repeater service to receive a message using BLUETOOTH® and to retransmit the message using a different communication protocol or also using BLUETOOTH® communication protocol.

Base station may also include a second transceiver or a wired interface having access to another communication network. The second transceiver or wired interface may retransmit the signal received from the device or received from some other device. In this way, central communication base station may serve to extend the communication range of the device. For example, a message between the device and an emergency-dispatch center may be coupled to communication with the base station connected network and a short range wireless network. Communications between the present subject matter and a device coupled to communicate with the base station connected network may be considered long range communications.

Base station may also communicate bidirectionally within the premise with one or more additional compatible devices. These may be a second device or any other device.

The base station connected network may be a public switched telephone network (PSTN), a pager communication network, a cellular communication network, a radio communication network, the Internet, or some other communication network. It will be further appreciated that with a suitable repeater, gateway, switch, router, bridge or network interface, the effective range of communication of a short range transceiver may be extended to any distance. For example, base station may receive transmissions on a BLUETOOTH® communication protocol and provide an interface to connect with the base station connected network, such as the public switched telephone network (PSTN) using the base station link. In this case, a wired telephone at a remote location can be used to communicate with the device. As another example, the range may be extended by coupling a BLUETOOTH® transceiver with a cellular telephone network, a narrow band personal communication systems (PCS) network, a CELLEMETRY® network, a narrow band trunk radio network or other type of wired or wireless communication network.

Examples of devices compatible with such long range protocols include, but are not limited to, a telephone coupled to the public switched telephone network (PSTN), a cellular telephone, a pager (either one way or two way), a personal communication device (such as a personal digital assistant, PDA), a computer, or other wired or wireless communication device.

In one embodiment, the long distance network may include a telephone network, which may include an intranet or the Internet. Coupling to such a network may be accomplished, for example, using a variety of connections, including a leased line connection, such as a T-1, an ISDN, a DSL line, or other high-speed broadband connection, or it may entail a dial-up connection using a modem. In one embodiment, the long distance network may include a radio frequency or satellite communication network. In addition, one or more of the aforementioned networks may be combined to achieve desired results.

Short range communication protocols, compatible with the base station may include, but are not limited to, wireless protocols such as HomeRF™, BLUETOOTH®, wireless LAN (WLAN), or other personal wireless networking technology. HomeRF™, currently defined by specification 2.1, provides support for broadband wireless digital communications at a frequency of approximately 2.45 GHz.

Other long range and short range communication protocols are also contemplated and the foregoing examples are not to be construed as limitations but merely as examples.

The base station may be compatible with more than one communication protocol. For example, the base station may be compatible with three protocols, such as a cellular telephone communication protocol, a two-way pager communication protocol, and BLUETOOTH® protocol. In such a case, a particular the device may be operable using a cellular telephone, a two-way pager, or a device compatible with BLUETOOTH®.

In one embodiment, the device can communicate with a remote device using more than one communication protocols. For example, the device may include programming to determine which protocol to use for communicating.

The determination of which communication protocol to use to communicate with a remote device may be based on power requirements of each transceiver, based on the range to the remote device, based on a schedule, based on the most recent communication from the remote device, or based on any other measurable parameter. In one embodiment, the device communicates simultaneously using multiple protocols.

In one embodiment, signals generated by the device are received by a central monitoring station. The central monitoring station may include operators that provide emergency dispatch services. An operator at the central monitoring station may also attempt to verify the authenticity of a received alarm signal. In one embodiment, the alarm signal generated by the device is first transmitted to a user, using either a short range or long range communication protocol, who then may forward the alarm signal to a monitoring station if authentic or cancel the alarm signal if the alarm is not valid.

In one embodiment, the device may communicate with a building control or security system by communicating using its transceiver. For example, the device may operate as an auxiliary input to a building control or security system. In which case, if the device detects a security event, by way of a sensor coupled to the device, then an alarm signal is transmitted from the device, via its transceiver, to the building security system. The building security system, if monitored by a central monitoring station, then forwards the alarm signal to the monitoring station. In one embodiment, the device can receive a transmission from a separate building control or security system. If the building security system detects an alarm condition, then the security system can, for example, instruct the device to repeatedly toggle power to load a flashing light visible from the exterior of the building may aid emergency personnel in locating an emergency site. Alternatively, the device can establish communications with a predetermined remote device or a central monitoring service.

In one embodiment, there are various types of networks connected to the base station. These may be telephone networks, modem connections, frame relay systems, spread-spectrum, DSL, cable modems, dedicated line or other similar wire based communication and data networks. In addition, these may be long-range, bidirectional, wireless networks as describe above.

In one embodiment, there is a connection to the Internet using various Internet protocols such as TCP/IP/HTTP/HTCP and others.

In addition, feedback may be transmitted to a remote device based on the operation of the device. For example, if a user issues a command to the device using the cellular telephone, then the display of the phone will indicate the changes arising from the command. In one embodiment, the cellular telephone, the base station, emergency monitoring center, or other device, displays real time information from the device.

Various methods may be used to communicate with, or send a message or instruction to, the device from a remote location. For example, using a cellular telephone, a user may speak a particular phrase, word or phoneme that is recognized by the cellular telephone which then generates and transmits a coded message to the device. As another example, the user may manipulate a keypad on the telephone to encode and transmit a message to the device.

In one embodiment, there are multiple destinations for the transmitted information. This may include a base station (at a home), multiple cell phones (or other network devices—for example, to notify a parent of the use of the device) or an emergency-dispatching center.

Conclusion

It is to be understood that the above description is intended to be illustrative, and not restrictive. It will be appreciated that the methods described herein may be performed in different orders than described and that portions of a method may be repeated. Many other embodiments will be apparent to those of skill in the art upon reviewing the above description. The scope of the invention should, therefore, be determined with reference to the appended claims, along with the full scope of equivalents to which such claims are entitled.

What is claimed is:

1. An apparatus comprising:
an accelerometer adapted for generating an acceleration signal based on a detected acceleration;
a processor coupled to the accelerometer and executing a set of instructions adapted for analyzing the acceleration signal; and
a transceiver coupled to the processor and adapted to wirelessly receive an address for a monitoring device and adapted to transmit an alarm signal based on the acceleration signal to the address.

2. The apparatus of claim 1 further comprising a memory coupled to the processor and wherein the memory is adapted to store a profile for comparison with the acceleration signal.

3. The apparatus of claim 1 further comprising a housing adapted for affixation to a monitored object.

4. The apparatus of claim 1 wherein the accelerometer has a maximum sensitivity to motion in a predetermined plane.

5. The apparatus of claim 1 wherein the accelerometer includes a mercury element.

6. The apparatus of claim 1 wherein the accelerometer includes a conductive ball element.

7. The apparatus of claim 1 wherein the transceiver includes a spread spectrum frequency hopping transceiver.

8. The apparatus of claim 1 wherein the transceiver is substantially compatible with a protocol of BLUETOOTH™ technical specification version 1.0.

9. The apparatus of claim 1 wherein the transceiver includes a cellular telephone transceiver or a two-way pager transceiver.

10. The apparatus of claim 1 further including a battery power supply coupled to the processor and transceiver.

11. A method comprising:
generating an acceleration signal based on a detected acceleration;
executing a set of computer instructions to analyze the acceleration signal;
wirelessly receiving an address for a monitoring device; and
wirelessly transmitting an alarm signal based on the acceleration signal to the address.

12. The method of claim 11 further comprising wirelessly receiving an activation instruction.

13. The method of claim 11 further comprising wirelessly receiving transmission protocol instructions.

14. The method of claim 11 further comprising affixing an accelerometer to a structure.

15. A method comprising:
receiving an electronic address for an accelerometer;
transmitting a configuration message to the electronic address from a wireless transmitter having a destination address, the configuration message including the destination address; and
awaiting receipt of an alarm message at the destination address.

16. A method of operating a wireless accelerometer sensor coupled to a monitored object, the method comprising:
transmitting an authorized destination address to the sensor;
configuring a transmitter of the sensor to wirelessly transmit an alarm message to the authorized destination address and preclude transmission to a non-authorized destination address; and
awaiting receipt of an alarm message at the destination address.

17. The method of claim 16 further comprising receiving an alarm signal from an accelerometer.

18. The method of claim 17 further comprising filtering the alarm signal.
